(19) United States
(12) Patent Application Publication
(10) Pub. No.: US 2021/0269139 A1
(43) Pub. Date: Sep. 2, 2021

(54) AIRCRAFT HAVING A FLOOR AND A FIRE AND/OR FUME PROTECTION FLAP

(71) Applicant: Airbus Operations SAS, Toulouse (FR)

(72) Inventor: Christophe CASSE, TOULOUSE (FR)

(21) Appl. No.: 17/181,389

(22) Filed: Feb. 22, 2021

(30) Foreign Application Priority Data
Feb. 24, 2020 (FR) 2001812

(51) Int. Cl. B64C 1/18

(52) U.S. Cl. CPC B64C 1/18

(57) ABSTRACT

An aircraft having a structure, a fuselage, a floor separating the fuselage in two, wherein the floor has openings, and, for each opening, a shut-off system having a flap hinged on the structure between a standby position in which the flap does not shut off the opening and a protective position in which the flap shuts off the opening, a return arrangement that urges the flap into the protective position and a retaining element that keeps the flap in the standby position and breaks when its temperature exceeds its melting point. Thus, when a high-temperature gas flow reaches the retaining element and this high temperature is higher than the melting point of the retaining element, the latter breaks and releases the flap, which shuts off the opening.

### CROSS-REFERENCES TO RELATED APPLICATIONS

This application claims the benefit of the French patent application No. 2001812 filed on Feb. 24, 2020, the entire disclosures of which are incorporated herein by way of reference.

### FIELD OF THE INVENTION

The present invention relates to an aircraft having a fuselage with a floor and openings allowing a flow of air to pass between the space above the floor and the space beneath the floor and a shut-off system configured to shut off the openings in the event that a high-temperature gas flow is present, whether this flow originates from a fire or is a matter of hot fumes.

### BACKGROUND OF THE INVENTION

An aircraft, in particular a commercial aircraft, conventionally has a fuselage in which there is installed a floor that separates the interior volume of the fuselage into a passenger space above the floor and a hold beneath the floor.

In order to ensure a flow of air in the passenger space, the floor has openings that allow communication between the passenger space and the hold. Fresh air is thus introduced into the passenger space by way of ventilation openings, and stale air is evacuated by way of the openings in the floor.

With such an installation, it is necessary to provide a protection system if a high-temperature gas flow, such as fumes, is present in the hold, in order to prevent this gas flow from reaching the passenger space.

### SUMMARY OF THE INVENTION

An object of the present invention is to propose an aircraft having a fuselage with a floor and openings allowing a flow of air to pass between the passenger space above the floor and the hold beneath the floor and a shut-off system configured to shut off the openings if a gas flow with a high temperature reaches these openings.

To that end, an aircraft is proposed, having:
a structure,
a fuselage fixed to the structure,
a floor fixed to the structure and installed in the fuselage, separating an interior volume of the fuselage into a passenger space above the floor and a hold beneath the floor, wherein the floor has openings between the passenger space and the hold.

According to the invention, for each opening, the aircraft has a shut-off system having a flap mounted on the structure in a manner hinged between a standby position in which the flap does not shut off the opening and a protective position in which the flap shuts off the opening, return means that urge the flap into the protective position and a retaining element that keeps the flap in the standby position and breaks when its temperature exceeds its melting point.

Thus, when a high-temperature gas flow reaches the retaining element and this high temperature is higher than the melting point of the retaining element, the latter breaks and releases the flap, which shuts off the opening.

According to one particular embodiment, the shut-off system has a foldable plate made up of the flap and of a fixed part, the fixed part being fixed to the structure, the flap is extended by the fixed part, which is joined to the flap along a fold line, the flap is folded with respect to the fixed part along the fold line when the flap is in the standby position, so as to form a fold, the hinge line of the flap corresponds to the fold line, and the folding of the flap when the flap is in the standby position corresponds to an elastic deformation.

According to another particular embodiment, the flap is fixed to the structure by way of a hinge, and the return means are formed by a spring that urges the flap into the protective position.

Advantageously, the retaining element is made up of at least one rod that is fixed between the flap and the structure or the fixed part.

Advantageously, the retaining element is made up of a first and a second rod, each first and second rod having a first and a second end, the flap has a free edge, the free edge having two ends, the first end of the first rod is fixed to one of the two ends of the free edge of the flap, the first end of the second rod is fixed to the other of the two ends of the free edge, the second end of the first rod and the first end of the second rod are generally opposite one another, and the second end of the second rod and the first end of the first rod are generally opposite one another.

### BRIEF DESCRIPTION OF THE DRAWINGS

The abovementioned features of the invention, along with others, will become more clearly apparent upon reading the following description of an exemplary embodiment, the description being given with reference to the appended drawings, in which:

FIG. 1 is a front view in cross section of an aircraft according to the invention,

FIG. 2 is an enlargement of a shut-off system in the standby position,

FIG. 3 is a view similar to FIG. 2 in the protective position,

FIG. 4 is a view of the shut-off system along the arrow IV in FIG. 2,

FIG. 5 is a view of an alternative embodiment of the shut-off system in the standby position, and

FIG. 6 is a view similar to FIG. 5 in the protective position.

### DETAILED DESCRIPTION OF THE PREFERRED EMBODIMENTS

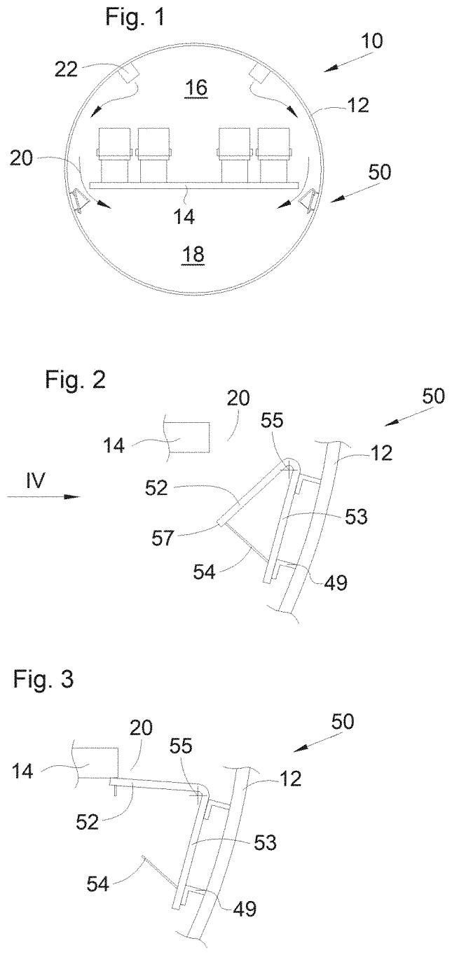

FIG. 1 shows an aircraft 10 that has a structure (49, FIG. 2), a fuselage 12 that is fixed to the structure 49 and in which there is installed a floor 14 that is fixed to the structure 49 and separates the interior volume of the fuselage 12 into a passenger space 16 above the floor 14 and a hold 18 beneath the floor 14.

In order to ensure a flow of air in the passenger space 16, the floor 14 has openings 20 that allow communication between the passenger space 16 and the hold 18. In the embodiment of the invention that is presented in FIG. 1, the openings 20 are made at the ends of the floor 14, but they can be made elsewhere in the floor 14.

Fresh air is thus introduced into the passenger space 16 by way of ventilation openings 22, and stale air is evacuated by way of the openings 20 in the floor 14.

The air thus circulates from the ventilation openings 22 to the passenger space 16, then through the openings 20 to the hold 18.

In order to avoid a high-temperature gas flow, such as fumes, for example, spreading from the hold 18 to the passenger space 16, for each opening 20, the aircraft 10 has a shut-off system 50.

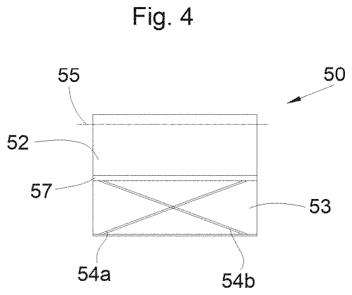

FIG. 2 and FIG. 4 show the shut-off system 50 in a first position in which it does not prevent the passage of the air, and FIG. 3 shows the shut-off system 50 in a second position in which it prevents the passage of the air, of a potential high-temperature gas flow, of fumes and of fire.

The shut-off system 50 has a flap 52 that is mounted on the structure 49 in a manner hinged along a hinge line 55 and is able to move between a standby position and a protective position. For better protection against fire, the flap 52 is made of a heat-resistant, and, in particular, fire-resistant, material, such as metal, titanium or Inconel®, for example.

In the standby position, the flap 52 does not shut off the opening 20, thereby allowing the passage of the air, in particular, of the air coming from the passenger space 16. This standby position corresponds to the first position of the shut-off system 50.

In the protective position, the flap 52 shuts off the opening 20, thereby preventing the passage of the air, and, more particularly, of a high-temperature gas flow and therefore of the fumes. This protective position corresponds to the second position of the shut-off system 50.

The shut-off system 50 also has return means that urge the flap 52 into the protective position and a retaining element 54 that keeps the flap 52 in the standby position and breaks when its temperature exceeds a threshold temperature. The threshold temperature corresponds to the temperature at which the retaining element 54 melts and which is reached when a fire starts. The threshold temperature is the melting point of the retaining element 54.

Thus, as long as the temperature is below the threshold temperature, the retaining element 54 remains intact and keeps the flap 52 in the standby position, and when the temperature becomes higher than the threshold temperature, the retaining element 54 breaks and releases the flap 52, which is positioned in the protective position, shutting off the opening 20, thereby avoiding the introduction of the high-temperature gas flow, of fumes and of the fire into the passenger space 16.

Such a shut-off system 50 is simple and inexpensive to implement.

In the embodiment of the invention that is presented here, the shut-off system 50 is disposed beneath the floor 14 and, in the standby position, the flap 52 is lowered. In the protective position, the flap 52 is lifted and comes to bear beneath the floor 14.

In the embodiment presented in FIGS. 1 to 4, the flap 52 is extended by a fixed part 53 that is fixed to the structure 49 and is joined to the flap 52 along a fold line, and the hinge line 55 of the flap 52 corresponds to the fold line between the flap 52 and the fixed part 53. The flap 52 and the fixed part 53 together constitute a foldable plate. In this embodiment, the flap 52 is thus fixed indirectly to the structure 49 by way of the fixed part 53.

In the standby position, the flap 52 is folded with respect to the fixed part 53 along the fold line, and in the protective position, the flap 52 is unfolded. In the standby position, the flap 52 thus forms a fold.

The return means are then formed by the internal structure of the foldable plate itself and by the fact that the folding when the flap 52 is in the standby position corresponds to an elastic deformation of the foldable plate, i.e., when the flap 52 is not urged into the standby position, it unfolds and returns to the protective position. In other words, a part of the flap 52, along the fold line, undergoes elastic deformation when the flap 52 is in the standby position.

In this embodiment, the foldable plate is, for example, an elastic metal leaf.

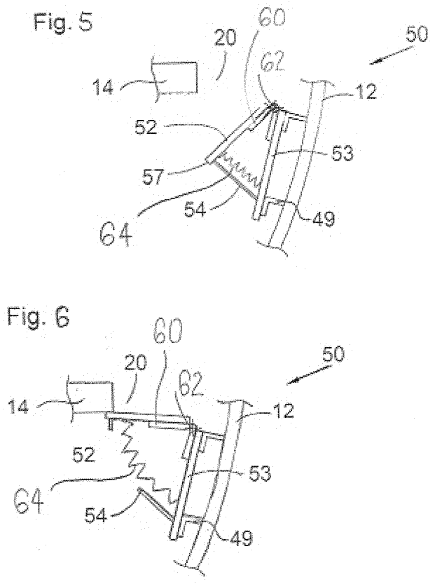

In another embodiment shown in FIGS. 5 and 6, the fold line is replaced by a hinge 60 and the flap 52 is then fixed to the structure 49 by way of the hinge 60 and the hinge line 55 of the first embodiment is the axis 62 of the hinge 60. The return means are formed, for example, by a spring 64 that urges the flap 52 into the protective position (FIG. 6).

According to one particular embodiment, the retaining element 54 is made up of at least one rod, for example made of plastic, wherein each rod is fixed between the flap 52 and the structure 49 or the fixed part 53.

FIG. 4 shows a particular embodiment, in which the retaining element 54 is made up of two rods 54a-b, wherein one end of each rod 54a-b is fixed to the flap 52 and wherein the other end of each rod 54a-b is fixed to the fixed part 53, but could be fixed to the structure 49.

The free edge 57 of the flap 52, i.e., the edge of the flap 52 that is not fixed to a rod 54a-b, extends parallel to the hinge line 55, the first end of the first rod 54a is fixed to one of the ends of the free edge 57, and the first end of the second rod 54b is fixed to the other end of the free edge 57.

The second end of the first rod 54a and the first end of the second rod 54b are generally opposite one another, i.e., they are generally coplanar with respect to a plane perpendicular to the hinge line.

The second end of the second rod 54b and the first end of the first rod 54a are generally opposite one another, i.e., they are generally coplanar with respect to a plane perpendicular to the hinge line.

The term “generally” should be understood here to mean that the two rods 54a-b cover, as much as possible, the extent of the flap 52 parallel to the hinge line 55.

Thus, the two rods 54a-b cross and, regardless of the position of the fire along the hinge line 55, the two rods 54a-b will be necessarily impacted simultaneously and will break in order to release the flap 52.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising:
a structure,
a fuselage fixed to the structure,
a floor fixed to the structure and installed in the fuselage, separating an interior volume of the fuselage into a passenger space above the floor and a hold beneath the floor,
wherein the floor has openings between the passenger space and the hold, and
wherein, for each opening, said aircraft has a shut-off system comprising:
a flap mounted on the structure in a manner hinged along a hinge line between a standby position in which the flap does not shut off the opening and a protective position in which the flap shuts off the opening,
return means that urge the flap into the protective position, and
a retaining element that keeps the flap in the standby position and breaks when its temperature exceeds its melting point.

2. The aircraft according to claim 1,
wherein the shut-off system has a foldable plate made up of the flap and of a fixed part, the fixed part being fixed to the structure, the flap is extended by the fixed part, which is joined to the flap along a fold line, the flap is folded with respect to the fixed part along the fold line when the flap is in the standby position, so as to form a fold,
wherein the hinge line of the flap corresponds to the fold line, and
wherein the folding of the flap, when the flap is in the standby position, corresponds to an elastic deformation comprising the return means.

3. The aircraft according to claim 2, wherein the retaining element is made up of at least one rod that is fixed between the flap and the structure or the fixed part.

4. The aircraft according to claim 1,
wherein the flap is fixed to the structure by way of a hinge, and
wherein the return means are formed by a spring that urges the flap into the protective position.

5. The aircraft according to claim 4, wherein the retaining element is made up of at least one rod that is fixed between the flap and the structure.

6. The aircraft according to claim 3,
wherein the retaining element is made up of a first and a second rod, each first and second rod having a first and a second end,
wherein the flap has a free edge, said free edge having two ends,
wherein the first end of the first rod is fixed to one of the two ends of the free edge of the flap,
wherein the first end of the second rod is fixed to the other of the two ends of said free edge,
wherein the second end of the first rod and the first end of the second rod are generally opposite one another, and
wherein the second end of the second rod and the first end of the first rod are generally opposite one another.

7. The aircraft according to claim 5,
wherein the retaining element is made up of a first and a second rod, each first and second rod having a first and a second end,
wherein the flap has a free edge, said free edge having two ends,
wherein the first end of the first rod is fixed to one of the two ends of the free edge of the flap,
wherein the first end of the second rod is fixed to the other of the two ends of said free edge,
wherein the second end of the first rod and the first end of the second rod are generally opposite one another, and
wherein the second end of the second rod and the first end of the first rod are generally opposite one another.
